(19) United States
(12) Patent Application Publication
(10) Pub. No.: US 2026/0362510 A1
(43) Pub. Date: Nov. 12, 2026

(54) METHOD AND APPARTUS FOR 6G SESSION MANAGEMENT FUNCTION (SMF) SELECTION AND SESSION MANAGEMENT (SM) CONTEXT RETRIEVAL

(71) Applicant: InterDigital Patent Holdings, Inc., Wilmington, DE (US)

(72) Inventors: Michael Starsinic, Newtown, PA (US); Anuj Sethi, Ottawa (CA); Saad Ahmad, Montreal (CA)

(73) Assignee: InterDigital Patent Holdings, Inc., Wilmington, DE (US)

(21) Appl. No.: 19/202,230

(22) Filed: May 8, 2025

(51) Int. Cl. H04W 76/10; H04L 61/4511; H04W 8/22

(52) U.S. Cl. CPC H04W 76/10; H04L 61/4511; H04W 8/22

(57) ABSTRACT

Various methods, systems, and apparatuses are provided for session management (SM) context retrieval. A 5G session management function (SMF) may receive a protocol data unit (PDU) session establishment request including a 6G SM context identifier. The SMF may use the 6G SM context identifier to determine an identity of a function and/or a server that stores 6G SM context information. The SMF may retrieve the 6G SM context information from the identified server and/or function. The 6G SM context information may include an identity of an internet protocol (IP) anchor. The SMF may establish an N4 session with the IP anchor. The N4 message may include an indication that the N4 session is to be associated with an existing 6G PDU session. The SMF sends a PDU session establishment accept message including an indication that the 6G SM context information has been used to establish a PDU session.

### BACKGROUND

Evolution in generations of mobile networks, e.g., 3G, 4G, 5G to 6G introduces challenges in ensuring continuity for devices transitioning between these mobile networks. A 6G network offers enhanced capabilities, performance, and throughput. For that, the 6G network may use one or more 6G network functions (NFs) or 6G nodes that are different from conventional 5G networks. In an example, the 6G NFs or 6G nodes may be potentially incompatible with one or more existing 5G NFs or 5G nodes. In an example, the 6G NFs or 6G nodes may be isolated and/or inaccessible to the one or more existing 5G NFs or 5G nodes. The coexistence of 5G and 6G during a transition phase necessitates various interworking mechanisms to provide seamless connectivity, reuse resources, and ensure scalability. As a result, an interworking mechanism is needed to seamlessly maintain one or more existing data sessions of a device when the device transitions from a 5G network to a 6G network.

### SUMMARY

In an embodiment of the present disclosure, a method performed by a session management function (SMF) in a network node is provided. The method comprises receiving a protocol data unit (PDU) session establishment request message from an access and mobility management function (AMF) in a first node. The PDU session establishment request message comprises a sixth generation (6G) session management (SM) context identifier associated with an existing 6G PDU session. The PDU session establishment request message is indicative of an initial request for establishing a new PDU session. The method comprises identifying, based on the 6G SM context identifier, a second node that stores 6G context information. The method comprises retrieving the 6G context information from the identified second node. The 6G context information includes a first identity of an internet protocol (IP) anchor function in a third node that serves the existing 6G PDU session. The method comprises transmitting a request for establishing an N4 session to the IP anchor function based on the first identity. The request includes a first indication associated with the existing 6G PDU session. The method comprises establishing the N4 session with the IP anchor function based on the first indication associated with the existing 6G PDU session. The method comprises transmitting a PDU session establishment accept message to the AMF. The PDU session establishment accept message includes a second indication associated with establishing the new PDU session based on an existing 6G PDU session.

In an embodiment, identifying the second node that stores 6G context information comprises: performing a domain name system (DNS) lookup on the 6G SM context identifier; and obtaining an IP address of the second node.

In an embodiment, identifying the second node that stores 6G context information comprises: transmitting the 6G SM context identifier to a network repository function (NRF) in a fourth node; and receiving, from the NRF, an identity of the second node.

In an embodiment, retrieving the 6G context information from the identified second node includes retrieving the 6G context information from one of: a server, a network function (NF), a user data repository (UDR), or an unstructured data storage function (UDSF).

In an embodiment, the method further comprises transmitting, based on the 6G context information, a PDU session establishment response message indicative of a capability of establishing the new PDU session based on an existing 6G PDU session.

In an embodiment, the first indication includes an N4 session identifier (ID) associated with the existing 6G PDU session.

In an embodiment, the 6G context information further includes: a second identity of a policy control function (PCF) in a fourth node that serves the existing 6G PDU session, and a PCF session ID associated with the existing 6G PDU session.

In an embodiment, the method further comprises transmitting a request for establishing a session to the PCF based on the second identity, wherein the request includes the PCF session ID associated with the existing 6G PDU session.

In embodiment, the existing 6G PDU session and the new PDU session established based on the existing 6G PDU session are associated with same IP address.

In an embodiment, the second indication includes the same IP address.

In an embodiment of the present disclosure, a network node comprising a transceiver and a processor is provided. The transceiver and the processor are configured to receive, a PDU session establishment request message from an AMF in a first node. The PDU session establishment request message comprises a 6G SM context identifier associated with an existing 6G PDU session, wherein the PDU session establishment request message is indicative of an initial request for a new PDU session. The transceiver and the processor are configured to identify, based on the 6G SM context identifier, a second node that stores 6G context information. The transceiver and the processor are configured to retrieve the 6G context information from the identified second node. The 6G context information includes a first identity of an IP anchor function in a third node that serves the existing 6G PDU session. The transceiver and the processor are configured to transmit a request for establishing an N4 session to the IP anchor function based on the first identity, wherein the request includes a first indication associated with the existing 6G PDU session. The transceiver and the processor are configured to establish the N4 session with the IP anchor function based on the first indication associated with the existing 6G PDU session. The transceiver and the processor are configured to transmit a PDU session establishment accept message to the AMF. The PDU session establishment accept message includes a second indication associated with establishing the new PDU session based on an existing 6G PDU session.

In an embodiment, identifying the second node that stores 6G context information comprises: performing a DNS lookup on the 6G SM context identifier, and obtaining an IP address of the second node.

In an embodiment, identifying the second node that stores 6G context information comprises: transmitting the 6G SM context identifier to a NRF in a fourth node, and receiving, from the NRF, an identity of the second node.

In an embodiment, retrieving the 6G context information from the identified second node includes retrieving the 6G context information from one of: a server, a NF, a UDR, or a UDSF.

In an embodiment, the transceiver and the processor are further configured to transmit, based on the 6G context information, a PDU session establishment response message indicative of a capability of establishing the new PDU session based on an existing 6G PDU session.

In an embodiment, the first indication includes an N4 session ID associated with the existing 6G PDU session.

In an embodiment, the 6G context information further includes: a second identity of a PCF in a fourth node that serves the existing 6G PDU session, and a PCF session ID associated with the existing 6G PDU session.

In an embodiment, the transceiver and the processor are further configured to transmit a request for establishing a session to the PCF based on the second identity. The request includes the PCF session ID associated with the existing 6G PDU session.

In an embodiment, the existing 6G PDU session and the new PDU session established based on the existing 6G PDU session are associated with same IP address.

In an embodiment, the second indication includes the same IP address.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a flow diagram illustrating an example method of 6G protocol data unit (PDU) session establishment in interworking with 4G and/or 5G according to one or more embodiments;

FIG. 3 is a flow diagram illustrating an example 5G PDU session establishment when moving from 6G to 5G according to one or more embodiments;

FIG. 4 is a flow diagram for an example method for 4G packet data network (PDN) connection establishment when moving from 6G according to one or more embodiments;

FIG. 5 is a flow diagram illustrating an example method for a 6G PDU session establishment in the 6G network when moving from 4G or 5G according to one or more embodiments; and

FIG. 6 is a flowchart illustrating an example process performed by a 5G session management function (SMF) according to one or more embodiments.

### DETAILED DESCRIPTION

As discussed herein, one or more abbreviations in the following (non-exhaustive) list, shown in Table 1, may be used herein.

TABLE 1

| | |
|---|---|
| 5GC | 5G Core Network |
| AMF | Access and Mobility Management Function |
| API | Application Programmer Interface |
| DNN | Data Network Name |
| EPC | Evolved Packet Core |
| FQDN | Fully Qualified Domain Name |
| HSS | Home Subscriber Server |
| ID | Identifier |
| IP | Internet Protocol |
| IPv4 | IP version 4 |
| IPv6 | IP version 6 |
| MM | Mobility Management |
| MME | Mobility Management Entity |
| NAS | Non-Access Stratum |
| NF | Network Function |
| PCC | Policy Control and Charging |
| PCF | Policy Control Function |
| PCO | Protocol Configuration Options |
| PDN | Packet Data Network |
| PDU | Protocol Data Unit |
| PGW | PDN Gateway |
| PGW-C | PGW - Control Plane Function |
| PGW-U | PGW - User Plane Function |
| PLMN | Public Land Mobile Network |
| RAN | Radio Access Network |
| SM | Session Management |
| SMF | Session Management Function |
| S-GW | Serving Gateway |
| S-NSSAI | Single Network Slice Selection Assistance Information |
| UDM | User Data Management |
| UDR | User Data Repository |
| UE | User Equipment |
| UPF | User Plane Function |

A PDN connection may refer to a connection, or session, between a wireless transmit/receive unit (WTRU) and a user plane anchor. The PDN connection may allow one or more data packets to be sent between the WTRU and a data network. The data network may be associated with an access point name (APN). The connection between the WTRU and the user plane anchor is via an evolved packet core (EPC). The user plane anchor is a PDN gateway (PGW) or a function that includes a PGW functionality (e.g. a user plane function (UPF)+PGW-user plane function (PGW-U).

A PDU session may refer to a connection and/or session, between a WTRU and a user plane anchor. The connection may allow one or more data packets to be sent between the WTRU and a data network. The data network is associated with a data network name (DNN). The connection between the WTRU and the user plane anchor is via a 5GC. The user plane anchor is a UPF and/or a function that includes UPF functionality (e.g. a UPF+PGW-U).

A 6G PDU session refers to a connection and/or session, between a WTRU and a user plane anchor. The connection may allow one or more data packets to be sent between the WTRU and a data network. The data network is associated with a DNN. The connection between the WTRU and the user plane anchor may be via a 6G core network. The user plane anchor may be a 6G UPF and/or a function that includes 6G UPF functionality.

An EPC is the 4G core network.

A 5GC is the 5G core network.

A 6G UPF may include PGW-U and UPF (i.e. 5G UPF) functionality.

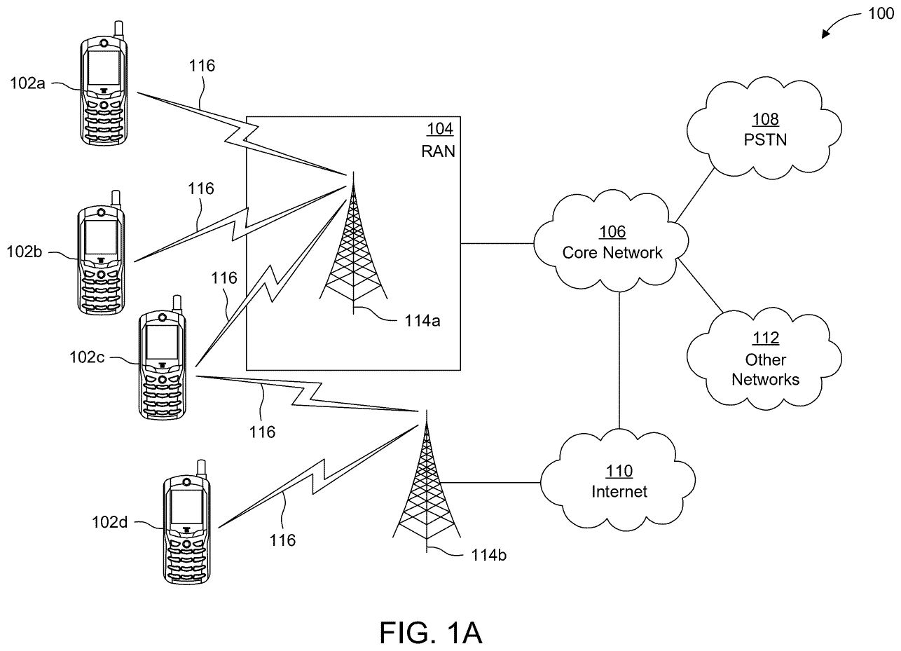

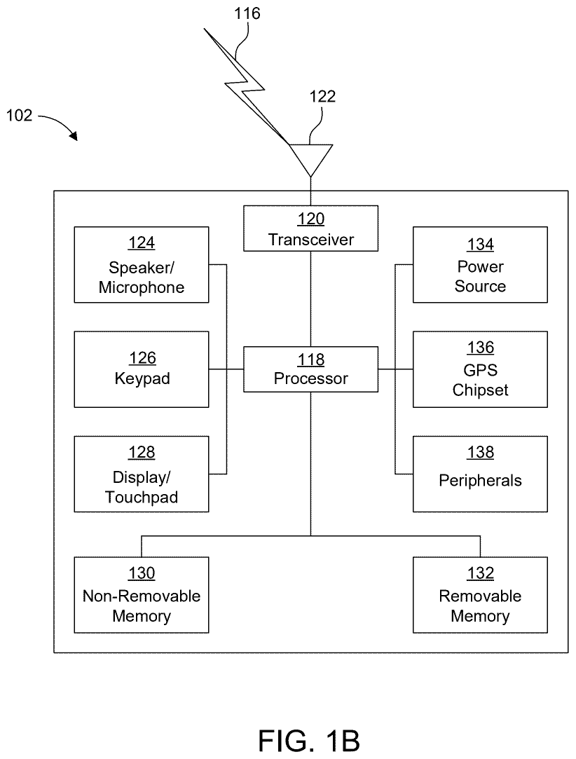

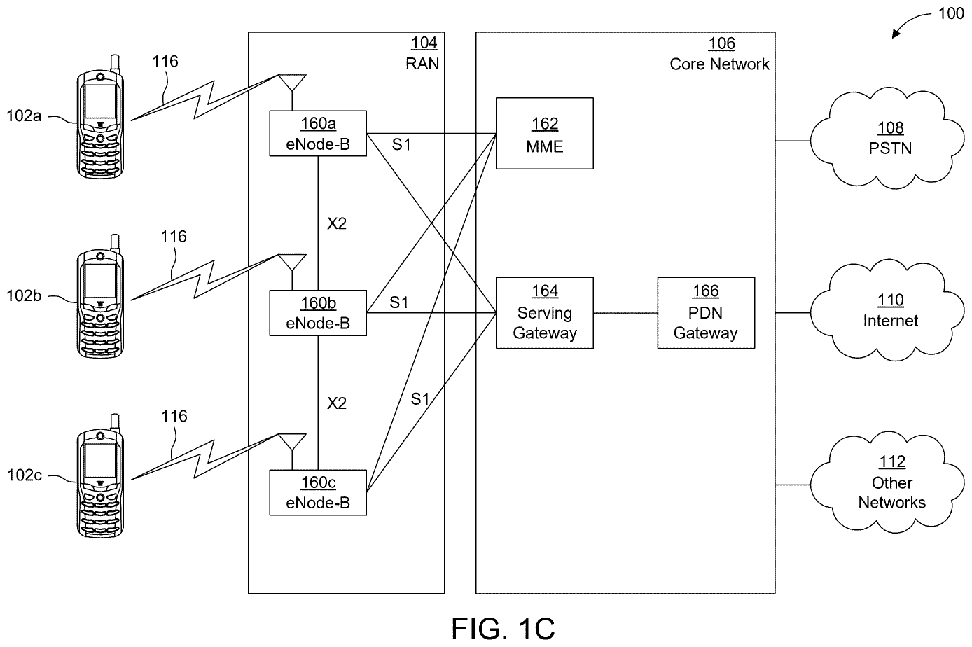

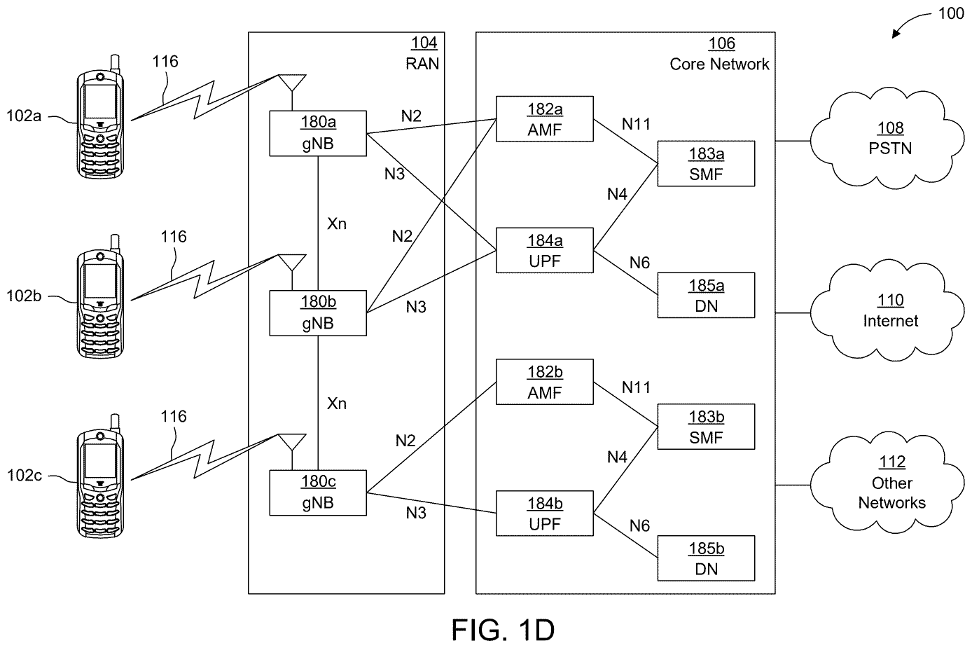

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Various techniques are used for different aspects of interworking between fifth generation (5G) and fourth generation (4G) networks. In order to facilitate interworking between 4G and 5G networks of an operator, the networks use a common subscriber database. In an example, a 4G subscriber database (e.g., home subscriber server (HSS)) and a 5G subscriber database (e.g., user data management (UDM) and/or user data repository (UDR)) are common databases. Various 5G network functions may access the database by invoking UDR and/or UDM application programming interfaces (APIs). Various 4G network nodes may access the databases via diameter messages. The database may be referred to as an HSS+UDM.

One or more support indications may be used in an initial attach procedure. When a wireless transmit/receive unit (WTRU) performs an initial attach procedure to the 4G network, the WTRU indicates to the network if the WTRU supports 5G non-access stratum (NAS) procedures. When a WTRU performs a registration procedure to the 5G network, the WTRU indicates to the network if the WTRU supports evolved packet core (EPC) NAS procedures.

Interworking may consider one or more packet data network (PDN) connection establishment considerations. If a WTRU supports 5GC NAS then, at PDN connection establishment in 4G, the WTRU may allocate a protocol data unit (PDU) session ID and send the PDU session ID via protocol configuration options (PCO) to the network. The PDU session ID may be encoded. During the PDN connection establishment procedure, the mobility management entity (MME) may select a session management function (SMF)+PDN gateway control plane function (PGW-C), e.g., SMF+PGW-C to serve the PDU session. The MME may know to select an SMF+PGW-C to serve the PDU session instead of a standalone PGW-C or standalone PDN GW because the WTRU indicated to the MME, during initial attachment, that the WTRU supports 5G NAS procedure.

When an N26 interface is not present between the 4G and 5G network, the SMF+PGW-C may store the SMF+PGW-C FQDN in SMF context in the HSS+UDM. When a PDN connection is moved to a PDU session, the AMF may retrieve the SMF+PGW-C fully qualified domain name (FQDN) from the HSS+UDM during a PDU session establishment procedure. When the N26 interface is present between the 4G and 5G network, the SMF+PGW-C does not need to store the SMF+PGW-C FQDN in SMF context in the HSS+UDM. When the PDN connection is moved to a PDU session, an access and mobility management function (AMF) may receive the identity of SMF+PGW-C FQDN from the MME via the N26 interface.

Interworking may consider one or more PDU session establishment considerations. During a PDU session establishment procedure, the AMF may select an SMF+PGW-C to serve the PDU session. The AMF may know to select an SMF+PGW-C to serve the PDU session instead of a standalone SMF because the WTRU indicated to the AMF, during registration, that the WTRU supports 4G NAS procedure. During the PDU session establishment procedure, when the WTRU moves from 4G to 5G, when the WTRU is in single registration mode, and/or when the N26 interface is not available, the WTRU may move a PDN connection to a PDU session by sending a PDU session establishment message to the 5G network and including an “Existing PDU Session” flag.

When the N26 interface is not present between the 4G and 5G network, the SMF+PGW-C may store the SMF+PGW-C FQDN in an SMF context in the HSS+UDM. When the PDU session is moved to a PDN connection, the MME may retrieve the SMF+PGW-C from the HSS+UDM during a PDN connection procedure. When the N26 interface is present between the 4G and 5G network, the SMF+PGW-C does not need to store the SMF+PGW-C FQDN in SMF context in the HSS+UDM. When the PDU session is moved to a PDN connection, the MME may receive the identity SMF+PGW-C from the AMF via the N26 interface.

The PDU session ID that is provided by the WTRU to the SMF+PGW-C in the PDU session establishment message is the same PDU session ID that was provided to the SMF+PGW-C in the PCO during the PDN connection establishment procedure. The SMF_PGW-C may use the PDU session ID to identify what PDN connection context relates to the PDU session that is being established.

In order facilitate internet protocol (IP) address preservation when a PDU session is moved to a PDN connection (and vice versa) a UPF+PGW-U must be selected to serve the PDU session. The same UPF+PGW-U is used when the WTRU moves between the 4G and 5G networks so that IP traffic of the WTRU may be routed via the same anchor node. The UPF+PGW-U may be selected by the MME when the PDN connection is established and/or by the SMF when the PDU session is established.

In order to facilitate a mobility of the WTRU between a 4G network and a 5G network, the interworking procedures of the EPS and 5GS require that a single SMF+PGW-C serve the PDU session and/or PDN connection. The SMF+PGW-C needs to support both 4G and 5G procedures. Thus, the design of interworking between 4G and 5G creates a situation where the functionality that controls the 4G and 5G data planes (e.g. the PDU sessions and PDN connections) is not isolated between the 4G and 5G networks. In an example, a single network node, and/or function, needs to control the data plane whether the WTRU is connected via 4G or 5G.

The MME performs PGW-C selection during PDN connection establishment. If the WTRU supports interworking, the MME may need to select an SMF+PGW-C to serve the PDN connection. Thus, the MME is limited in terms of what session management function it selects to serve the PDN connection.

When an MME performs PGW-C selection for a PDU session that is moving to the 4G as a PDN connection, the MME must select the SMF+PGW-C that is already serving the PDU session. Thus, the MME is not able to select an SMF+PGW-C based on 4G network conditions.

The AMF performs SMF selection during PDU session establishment. If the WTRU supports interworking, the AMF may need to select an SMF+PGW-C to serve the PDU session. Thus, the AMF is limited in terms of what session management function it selects to serve the PDU session.

When an AMF performs SMF selection for a PDN connection that is moving to the 5G as a PDU session, the AMF must select the SMF+PGW-C that is already serving the PDN connection. Thus, the AMF is not able to select an SMF+PGW-C based on 5G network conditions.

Thus, the conventional procedures for interworking between 4G and 5G networks do not allow for isolation of the 4G session management control functionality (i.e. the PGW-C) and 5G session management control functionality (i.e. the SMF). Furthermore, the conventional interworking procedures create limitations on what session management functionality can be selected by the MME and also create limitations on what session management functionality can be selected by the AMF.

Various techniques described in the present disclosure show how the 6G network can be designed such that one or more data sessions in the 4G and 5G networks can interwork with one or more 6G data network sessions. Some of the techniques are based on the WTRU following the procedure for establishing a new PDU session when the WTRU moves from the 6G network to the 5G network but adding a 6G SM context identifier to the NAS-SM PDU session establishment request. To minimize the impact on the 5G AMF, the 5G AMF can transparently pass the 6G SM context identifier to the SMF and hence, the 5G AMF can behave as if a new PDU session is being established. In other words, the AMF does not need to take special actions to account for the fact that the PDU session will be based on 6G SM context. The 5G SMF or SMF+PGW-C may then use the 6G SM context identifier to determine the identity of a function, or server, that stores SM context, retrieve the SM context, and use the SM context to establish the PDU session. Using the SM context to establish the PDU session includes ensuring that the PDU session is served by the same IP anchor (i.e. user plane function (UPF)) that served the 6G PDU session. Using the SM context to establish the PDU session includes ensuring that the PDU session is associated with the same IP address that was associated with the 6G PDU session.

In various techniques described in the present disclosure, it may be assumed that a combined 6G UPF+UPF+PGW-U network function, or node, is used as the IP anchor of a 6G PDU session, PDU session, or PDN connection and that one or more methods enable selection of the same combined 6G UPF+UPF+PGW-U network function, or node each time the WTRU moves to a new type of network (i.e. 4G/EPC, 5G/5GC, or 6G).

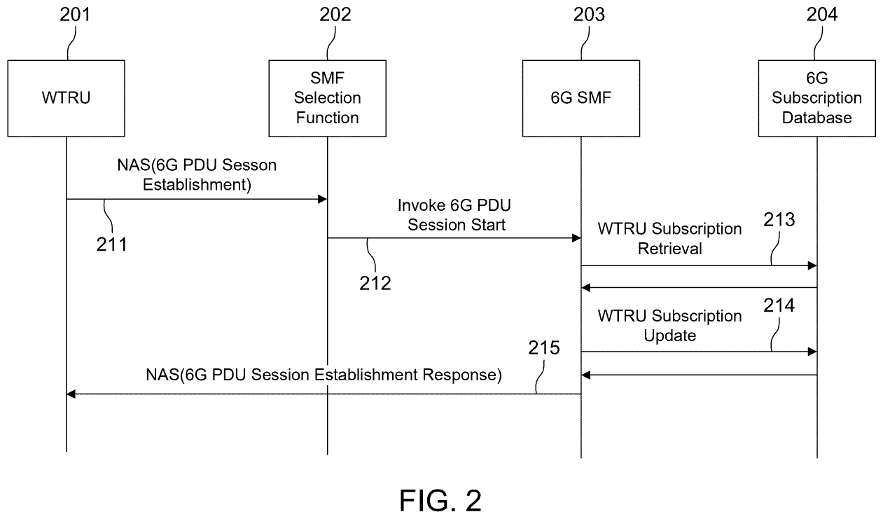

Referring now to FIG. 2, a flow diagram illustrating an example method of 6G PDU session establishment in interworking with 4G and/or 5G is shown according to one or more embodiments. The method is performed using a WTRU 201, an SMF selection function 202, a 6G SMF 203, and a 6G subscription database 204.

FIG. 2 shows an example of how a 6G PDU session may be established. In this example, the WTRU 201 may indicate to the network that the WTRU 201 supports communication with 4G and/or 5G networks. The WTRU 201 may also indicate to the network that the WTRU 201 desires that 4G and/or 5G interworking be supported for the 6G PDU session. If 4G interworking is supported for the 6G PDU session, then the WTRU 201 can move the 6G PDU session to a PDN connection when the WTRU 201 connects to a 4G network.

If 5G interworking is supported for the 6G PDU session, then the WTRU 201 can move the 6G PDU session to a PDU session when the WTRU 201 connects to a 5G network. As part of the 6G PDU session establishment procedure, the 6G SMF 203 may create a 6G SM context identifier and provide the 6G SM context identifier to the WTRU 201. The WTRU 201 may provide the 6G SM context identifier to the 4G network when the WTRU 201 moves to the 4G network, or the WTRU 201 may provide the 6G SM context identifier to the 5G network when the WTRU 201 moves to the 5G network. An SMF+PGW-C in the 4G or 5G network may use the 6G SM context identifier to retrieve the SM context for the PDU Session. Thus, the control plane session management function that serves the session when the WTRU 201 is connected to 6G does not need to be the same function that serves the session when the WTRU 201 is connected to 4G or 5G.

At 211, the WTRU 201 sends a NAS message to the network. The NAS message may be carried in an RRC message and the RRC message may include a field that indicates that the RRC message is a 6G PDU session establishment message. A 6G RAN node may receive the RRC message and, based on the indication that the message is a 6G PDU session establishment message, route the NAS message to an SMF selection function 202. The RAN node is not shown in FIG. 2.

The NAS 6G PDU session establishment message may include a DNN, an S-NSSAI, an indication that interworking with 4G is supported, an indication that interworking with 4G is desired, an indication that interworking with 5G is supported, and an indication that interworking with 5G is desired, an indication that interworking with 4G & 5G is supported, and/or an indication that interworking with 4G & 5G is desired etc., for example.

In an example, the inclusion of an indication that interworking with 4G is desired may also be an indication that interworking with 4G is supported.

In an example, the inclusion of an indication that interworking with 5G is desired may also be an indication that interworking with 5G is supported.

In an example, the inclusion of an indication that interworking with 4G & 5G is desired may also be an indication that interworking with 4G & 5G is supported.

Alternatively or additionally, an indication from the WTRU indicating support for the 4G/5G NAS e.g. support for N1 or/and S1 mode may be considered as an indication that interworking with 4G or/and 5G is supported.

At 212, the SMF selection function 202 may receive the NAS message and select a 6G SMF 203 to serve the 6G PDU session. The SMF selection function 202 may use a data network name (DNN) and a single network slice selection assistance information (S-NSSAI) in the 6G PDU session establishment message to select the SMF selection function 202. The SMF selection function 202 may use the indications from the WTRU 201 about whether the WTRU 201 prefers interworking with one or more 4G and/or 5G in the 6G SMF selection procedure. For example, the SMF selection function 202 may select a 6G SMF 203 that can store the WTRU context in a location that can be retrieved by an SMF+PGW-C and can generate a 6G SM context identifier. The SMF selection function 202 may invoke a 6G PDU session start service of the selected 6G SMF 203. As part of the service invocation, the SMF selection function 202 may send the 6G SMF 203 the information that was included in the in the 6G PDU session establishment request (e.g. the DNN, an S-NSSAI, an indication that interworking with 4G is supported, an indication that interworking with 4G is desired, an indication that interworking with 5G is supported, an indication that interworking with 5G is desired, an indication that interworking with 4G & 5G is supported, and/or an indication that interworking with 4G & 5G is desired etc.).

At 213, the WTRU 201 may retrieve information from the subscription of the WTRU 201. The information that is retrieved from the subscription may relate to the DNN and S-NSSAI combination that the WTRU 201 requested to be associated with the 6G PDU session. The information may indicate if the access of the WTRU 201 to the DNN and S-NSSAI combination is allowed to support interworking with 4G and/or 5G. If the subscription information does not indicate that the access of the WTRU 201 to the DNN and S-NSSAI combination is allowed to support interworking with 4G and/or 5G and, if the WTRU 201 indicated that interworking with 4G or 5G is desired, then the 6G SMF 203 may respond to the WTRU by sending a NAS PDU session establishment rejection message, the WTRU 201 may skip the rest of this procedure, and the NAS PDU session establishment rejection message may include a cause code that indicates that interworking with 4G and/or 5G is not supported for the DNN and/or S-NSSAI combination.

At 214, based on the 6G SMF 203 determining that interworking with 4G and/or 5G will be enabled for the PDU session, the 6G SMF 203 may assign a 6G SM context identifier to the 6G PDU session. The 6G SMF 203 may store the 6G SM context identifier in the subscription information of the WTRU 201.

Alternatively or additionally, the 6G SMF 203 may register the 6G SM context identifier with a DNS server. In other words, the 6G SMF 203 may register the 6G SM context identifier and the identity of the NF or server that may store the 6G PDU session context. The identity of the NF or server may be an IP address. Later, an SMF+PGW-C may use the 6G SM context identifier to perform a DNS lookup and determine where the SM context is stored. In other words, the result of the DNS look up may be the identity and/or IP address, of the NF or server where the SM context is stored.

The 6G PDU session establishment message may include a PDU session ID. The PDU session ID may be stored as part of the SM context. The 6G SM context identifier may have multiple fields. One field may be a WTRU identifier and another field may be the PDU session ID.

At 215, the 6G SMF 203 may send a 6G PDU session establishment response message to the WTRU. The 6G PDU session establishment response message may indicate to the WTRU 201 that the 6G PDU session was successfully established, whether interworking with 4G is allowed for the 6G PDU session, whether interworking with 5G is allowed for the 6G PDU session, and/or the 6G SM context identifier etc. The inclusion of the 6G SM context identifier in the 6G PDU session establishment response message may be an indication that interworking with 4G and/or 5G is supported for the 6G PDU session.

During the 6G PDU session establishment procedure of FIG. 2, the WTRU 201 may indicate to network that the WTRU 201 requests interworking with 4G and/or 5G for the 6G PDU session. The WTRU 201 may indicate the request for interworking in a 6G PDU session establishment message that the WTRU 201 sends to a 6G SMF 203. The indication may be made because the WTRU 201 supports communicating with 4G and/or 5G networks and because the WTRU 201 anticipates that the WTRU 201 may want to access the data network that is associated with the 6G PDU session if the WTRU 201 connects to a 4G or 5G network.

When the 6G SMF 203 receives an indication that the WTRU 201 wants to enable interworking with a 4G and/or 5G network for the 6G PDU session and the 6G SMF 203 determines that interworking with the 4G and/or 5G network should be authorized for the 6G PDU session, the 6G SMF 203 may perform an SMF+PGW-C pre-selection procedure.

The 6G SMF 203 may determine that interworking with the 4G and/or 5G network should be authorized for the 6G PDU session based on information in the subscription of the WTRU 201 that indicates that interworking should be allowed for 6G PDU sessions that are associated with the data network that is associated with the 6G PDU session.

The 6G SMF 203 may determine that interworking with the 4G and/or 5G network should be authorized for the 6G PDU session based on policies that are configured in the 6G SMF 203 and that indicate that interworking should be allowed for 6G PDU sessions that are associated with the data network that is associated with the 6G PDU session.

As described in the 6G PDU session establishment procedure of FIG. 2, the 6G SMF 203 may determine a storage location for the 6G SM context that is associated with the 6G PDU session. In the SMF+PGW-C pre-selection procedure, the 6G SMF 203 will determine the identities of one or more SMF+PGW-C network functions that can access the 6G SM context location. The 6G SMF 203 will then store the one or more identities of the SMF+PGW-C network functions in the subscription information of the WTRU 201. For example, storage in the subscription information of the WTRU 201 may take place in 214 of FIG. 2. The 6G SMF 203 will store the one or more identities of the SMF+PGW-C network functions in the subscription information with the PDU session ID and/or 6G context identifier and/or DNN. The one or more identities of the SMF+PGW-C network functions represent pre-selected SMF+PGW-C network functions. These pre-selected network functions may not serve the 6G PDU session when they are pre-selected. Rather, they may have been pre-selected because the 6G SMF 203 determines that the SMF+PGW-C network functions may be capable of serving the 6G PDU session if the 6G PDU session changes to become a 4G PDN connection or changes to become a 5G PDU session. The one or more identities of the SMF+PGW-C network functions which are pre-selected may represent the list of network functions (i.e., SMF+PGW-C) which are pre-authorized by the 6G SMF 203 and/or other 6G core network functions or pre-authorized based on the subscription information of the WTRU and/or DNN and/or S-NSSAI combination.

In an example, the subscription information may be accessible to the MME via an HSS interface, and the subscription information may be accessible to the AMF via a UDM interface.

The identities of the SMF+PGW-C network functions may be retrieved by an AMF, via a UDM interface, during an SMF selection procedure.

The one or more identities of the SMF+PGW-C network functions may be retrieved by an MME, via an HSS interface, during an SMF selection procedure.

In an example, session management context refers to information (i.e. the context) that is associated with a 6G PDU session, a PDU session (e.g., a 5G PDU session), and/or a PDN connection (e.g. a 4G PDN connection) etc. The information may include but is not limited to: the identity of a control plane node that serves the PDU session, 6G PDU session, and/or PDN connection etc. In an example, the identity of a PGW-C, SMF, 6G SMF, and/or an SMF+PGW-C, an IPv4 address, an IPv6 address, an IPv6 prefix, the identity of the user plane anchor that serves the PDU session, 6G PDU session, and/or PDN connection etc. may be included. In an example, the identity of a PGW-U, UPF, 6G UPF, and/or UPF+PGW-U, a PDU Session ID, an S-NSSAI, a DNN, and/or one or more policy control and charging (PCC) rules, and/or a DNAI etc., may be included.

Various embodiments provide techniques for PDU session establishment in the 5G network when moving from 6G. When the WTRU moves from 6G to 5G, the WTRU may send a PDU session establishment message to the 5G network in order to initiate moving the 6G PDU session to a 5G PDU session. The PDU session establishment message is an NAS-SM message. The NAS-SM message is sent to the network inside of a NAS-MM message. The NAS-MM message is sent to the AMF by the WTRU. The NAS-MM message may indicate that the request type is an “initial request”. The NAS-MM message may optionally include SMF selection assistance information. The SMF selection assistance information may include a 6G SM context identifier.

An advantage of indicating that the request type is an “initial request” is that the AMF will not need to select a specific SMF based on information the UDM. The AMF may perform SMF selection and use the SMF selection assistance information in the SMF selection procedure. The SMF selection assistance information is used by the AMF to ensure that the AMF selects an SMF that is able to retrieve the 6G SM context from where it was last stored in the 6G network.

The AMF may send the PDU session establishment request message to the selected SMF. Note that the selected SMF may be an SMF+PGW-C. The PDU session establishment request message may include the 6G SM context identifier. The 6G SM context identifier may be included in a PCO information element of the PDU session establishment request message or an existing and/or new NAS SM information element. The SMF may use the 6G SM context identifier to determine what 6G network and what 6G network node, network function, or storage location, to send a context retrieval request to. The SMF may use the 6G context identifier to identify what context needs to be retrieved.

In an example, optionally, the 6G SM context identifier may not be part of the PDU session establishment request message because the AMF may forward the 6G SM context identifier to the SMF when the AMF sends the PDU session establishment request message to the SMF.

An advantage of including the 6G SM context identifier in the PDU session establishment request message may be that the WTRU may optionally choose not to include the 6G SM context identifier in the NAS-MM part of the message. Thus, during SMF selection, the AMF would not need to consider that the purpose of the PDU session establishment is to move a 6G PDU session to a 5G PDU session. For example, the WTRU may determine to not include the 6G SM context identifier in the NAS-MM part of the message if the PLMN ID of the 5G network and the PLMN ID of the 6G network is the same value or if the PLMN ID that is associated with the 5G network is an equivalent PLMN of the PLMN ID that is associated with the 6G network. When the PLMNs are the same or equivalent, it may be assumed that all SMFs of the 5G network will be able to read the context that was stored in the 6G network and therefore the SMF selection assistance information would not need to be considered during SMF selection.

In operation, an SMF (e.g., a 5G SMF) receives a PDU session establishment request. The PDU session establishment request includes a 6G SM context identifier. The SMF uses the 6G SM context identifier to determine the identity of a function and/or server, that stores SM context. In an example, the identity of the function and/or server, may be based on a DNS lookup. In an example, the identity of the function and/or server, may be based on an NRF query. The SMF requests 6G PDU session context information from the identified server and/or function and receives the 6G PDU session context information from the identified server and/or function. The 6G PDU session context information includes the identity of an IP anchor. The SMF sends a message to the IP anchor to establish an N4 session with the IP anchor. The N4 message includes an indication that the N4 session is to be associated with an existing 6G PDU session. The indication that the N4 session is to be associated with an existing 6G PDU session may be the presence of an N4 session ID in the message. The SMF sends a PDU session establishment accept message. The PDU session establishment accept message includes an indication that context from an existing 6G PDU session has been used to establish the PDU session.

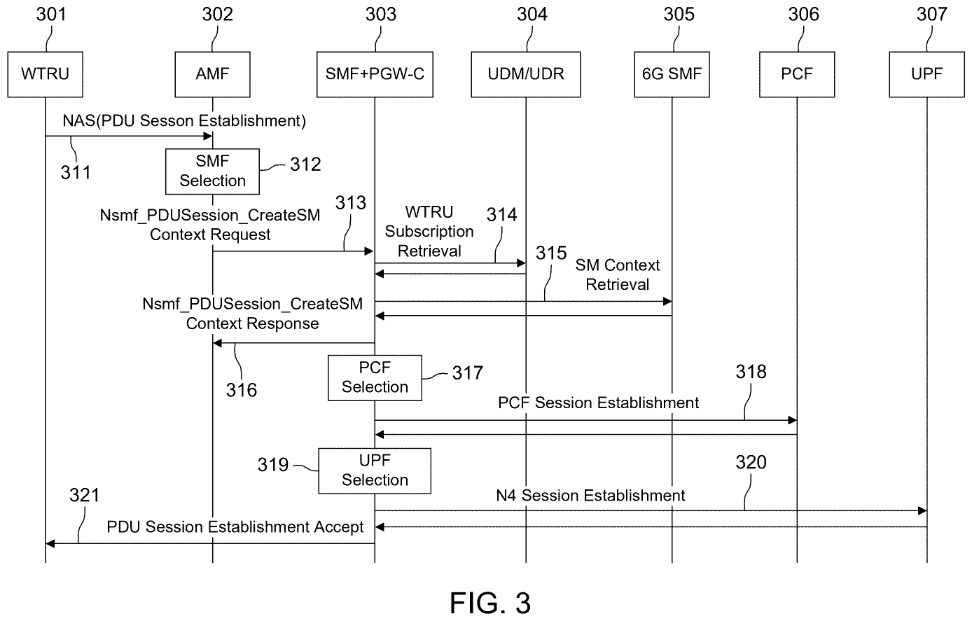

Referring now to FIG. 3, a flow diagram of an example 5G PDU session establishment when moving from 6G to 5G is shown according to one or more embodiments. FIG. 3 shows an example procedure for how a PDU session may be established in a 5G network such that the PDU session will be based on the context that was established in a 6G PDU session. The method may be implemented using a WTRU 301, an AMF 302, SMF+PGW-C 303, a UDM/UDR 304, a 6G SMF 305, a PCF 306, and a UPF 307. In an example, the method may be executed by the WTRU 301 after the 6G PDU session establishment procedure of FIG. 2 and after the WTRU 301 registers with the 5G network. In an example, the WTRU 301 may trigger this procedure based on deciding to move the 6G PDU session that was established in the procedure of FIG. 2 to a PDU session in the 5G network. FIG. 3. shows an example 5G PDU session establishment when moving from 6G to 5G.

At 311, the WTRU 301 may send a PDU session establishment request message to the network. The PDU session establishment request message may be sent to the AMF 302 inside of a NAS-MM message. The WTRU 301 may include a new PDU session ID in the NAS-MM message. The NAS-MM message may indicate that the request type is a “initial request”. The new PDU session ID may be new to the 5G but may also be the same PDU Session ID that was provided to the 6G network by the WTRU 201 in the procedure of FIG. 2. Thus, the AMF 302 may handle the PDU session establishment request message as if the request is for establishing a new PDU session.

The PDU session establishment request message may include the 6G SM context identifier that was received by the WTRU 301 in the procedure of FIG. 2. The 6G SM context identifier may be included in the PCO information element.

At 312, the AMF 302 may perform an SMF selection procedure. In an example, handling the PDU session establishment request message as if the request is for establishing a new PDU session means that the AMF 302 may select an SMF without considering whether the PDU session will be reusing context information from 6G. The AMF 302 may select an SMF that is an SMF+PGW-C (e.g., the SMF+PGW-C 303).

At 313, the AMF 302 may invoke the Nsmf_PDUSession_CreateSMContext_Request service operation of the selected SMF. The PDU session establishment request message, which includes the 6G SM context identifier may be sent to the selected SMF in this step.

In 314, the selected SMF may retrieve session management related subscription data from the UDM/UDR 304. The session management subscription data relates to the authorization to access the DNN and of the WTRU 301 S-NSSAI that is associated with the PDU session. The subscription information may indicate if the WTRU 301 is permitted to interwork with 6G when PDU sessions are associated with the DNN and S-NSSAI.

In 315, the selected SMF may detect that a 6G SM context identifier is present in the PDU session establishment request. Based on the presence of the 6G SM context identifier, the selected SMF may infer that the PDU session should be based on session management context of 6G PDU session. The SMF may use the 6G SM context identifier to identify what NF or server stores the context of the 6G PDU session.

For example, the SMF may perform a DNS lookup on the 6G SM context identifier to obtain the IP address of the NF or a server may store the context of the 6G PDU session.

For example, the SMF may send the 6G SM context identifier to an NRF and the NRF may respond to the SMF with the identity of the NF or server that stores the context of the 6G PDU session.

The SMF may query the NF or server stores the context of the 6G PDU session. The NF or server may respond to the SMF by sending the context of the 6G PDU session to the SMF.

The context of the 6G PDU session context (i.e. the SM context) may include the identity of the UPF (i.e. IP anchor) that serves the 6G PDU session, and the identity of the PCF that serves the 6G PDU session.

FIG. 3 shows that the SMF+PGW-C 303 retrieves the context from a 6G SMF 305. In an example, the 6G SMF may have stored the context in a different function such as the UDR or an UDSF. Thus, 315 may be used to retrieve the context from a function such as a UDR or UDSF.

At 316, SMF may respond to the AMF 302 by sending a message that indicates that the SMF may process the PDU session establishment request.

At 317, the SMF may perform a PCF selection. In this PCF selection procedure, the SMF may select the PCF whose identity was received in the 6G PDU session context that was received in 315.

At 318, the SMF may establish a session with the selected PCF 306. The 6G PDU session context that was received in 315 may include the PCF session ID. The SMF may send the PCF session ID to the PCF 306 in this step so that the PCF 306 knows that the SMF is now the session management anchor for the connection of the WTRU 301 to the data network that is associated with the DNN and S-NSSAI combination. The PCF session ID is also used by the UPF 307 to determine that existing context should be used for the new PDU session in the 5G network.

At 319, the SMF performs UPF selection. In this UPF selection procedure, the SMF may select the UPF whose identity was received in the 6G PDU session context that was received in 315.

At 320, the SMF may establish an N4 session with the selected UPF 307. The 6G PDU session context that was received in 315 may include the N4 Session ID. The UPF 307 may send the N4 Session ID to the UPF 307 in this step so that the UPF 307 knows that the SMF is now the session management anchor for the connect of the WTRU 301 to the data network that is associated with the DNN and S-NSSAI combination. The N4 session ID may also be used by the UPF 307 to determine that existing context should be used for the new PDU session in the 5G network.

At 321, the SMF may send a PDU session establishment accept message to the WTRU 301. The PDU session establishment accept message may include an indication that context from an existing 6G PDU session has been used to establish the PDU session. The presence of an allocated IPv4 address value in the PDU session establishment accept message that is the same as an IPv4 address that is already associated with the PDU session ID may be an indication that the context from the 6G PDU session has been used to establish the PDU session.

Various embodiments of the present disclosure provide one or more methods for PDN connection establishment in the 4G network when moving from 6G.

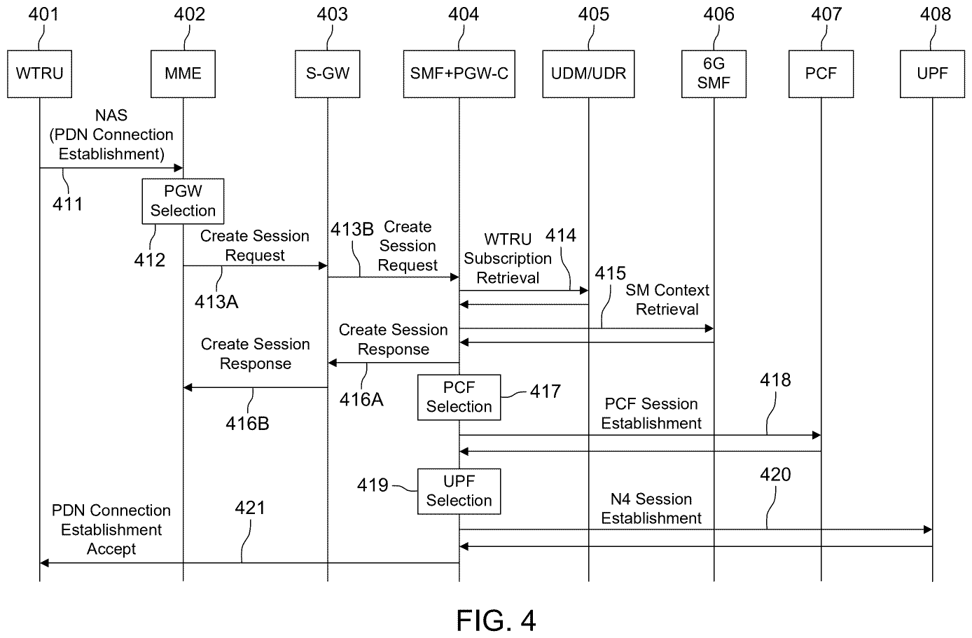

Referring now to FIG. 4, a flow diagram for an example method for 4G PDN connection establishment when moving from 6G is shown according to one or more embodiments. FIG. 4 shows an example procedure for how a PDN connection may be established in a 4G network such that the PDN connection may be based on the context that was established in a 6G PDU session. The method may be performed using a WTRU 401, MME 402, S-GW 403, SMF+PGW-C 404, UDM/UDR 405, 6G SMF 406, PCF 407, and UPF 408. In an example, the method may be executed by the WTRU 201 after the 6G PDU session establishment procedure of FIG. 2 and after the WTRU 201 attaches to the 4G network. In an example, the WTRU 301 may trigger this procedure based on deciding to move the 6G PDU session that was established in the procedure of FIG. 2 to a PDN connection in the 4G network.

At 411, the WTRU 401 may send a PDN connection establishment request message to the network. The message may be sent to the MME 402. The PDU session establishment request message may include the 6G SM context identifier that was received by the WTRU 201 in the procedure of FIG. 2. The 6G SM context identifier may be included in the PCO information element.

At 412, the MME 402 may perform a PGW selection procedure as if the request is for establishing a new PDN connection. in an example, handling the message as if the request is for establishing a new PDN connection means that the MME selects a PGW-C without considering whether the PDU session will be reusing context information from 6G. The MME 402 may select an SMF that is an SMF+PGW-C.

At 413, the MME 402 may send a create session request message to an S-GW 403. The message may include the identity of the selected SMF+PGW-C 404. A 6G SM context identifier may be sent to the S-GW 403. The S-GW 403 will send the 6G SM context identifier to the selected SMF+PGW-C 404.

414-419 are similar to 314-315 and 317-320 of FIG. 3.

At 420, the SMF+PGW-C 404 may respond by sending a create session response to the GW S-403 and the S-GW 403 sends a create session response to the MME 402.

At 421, the MME 402 may send a PDN connection establishment accept message to the WTRU 401. The PDN connection establishment accept message may include an indication that context from an existing 6G PDU session has been used to establish the PDN connection. The presence of an allocated IPv4 address value in the PDN connection establishment accept message that is the same as an IPv4 address that is already associated with the PDU session ID may be an indication that the context from the 6G PDU session has been used to establish the PDU session.

In an example, the method may be used for 6G PDU session establishment in the 6G network when moving from 4G or 5G. When the WTRU 401 registers to the 6G network when moving from a 5G network, a network function in the 6G network may be triggered to retrieve WTRU context information from the AMF.

When the WTRU 401 registers to the 6G network when moving from a 4G network, a network function in the 6G network may be triggered to retrieve WTRU context information from MME.

The context information may include session management context information. The session management context information may include one or more PDU session IDs and the identity of an SMF+PGW-C 404 that is associated with the PDU session.

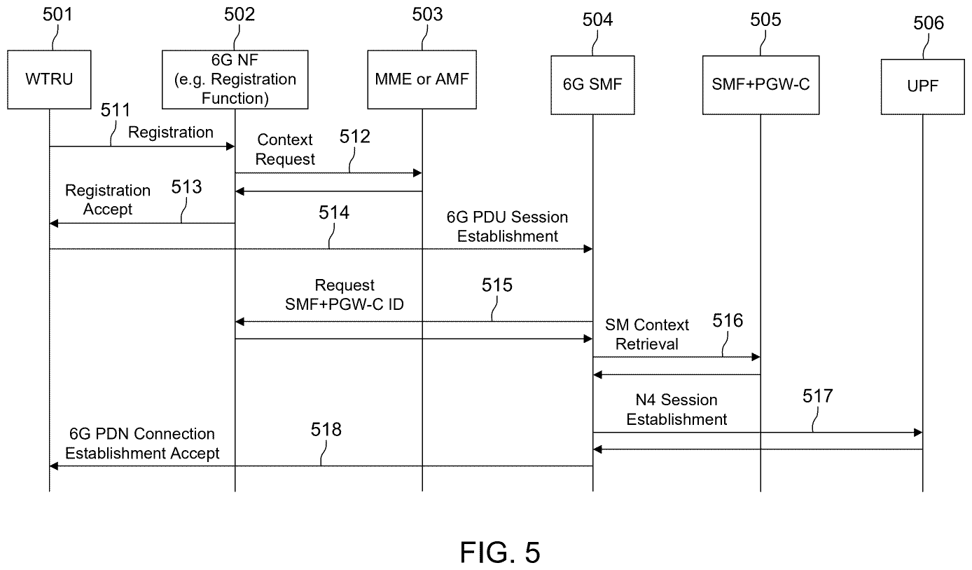

When the WTRU establishes a 6G PDU session, a 6G SMF 406 may receive a PDU session establishment request from the WTRU 401. The PDU session establishment request may include information that indicates that the PDU session that is being established in 6G should reuse context information from a PDN connection that was established in a 4G network or a PDU session that was established in a 5G network. The PDU session establishment request may include the PDU session ID that is associated with the PDN connection or PDU session. The 6G SMF 406 may use the PDU session ID to query the network that retrieved the context of the WTRU 401 from the MME 402 or AMF. In response to the query, the 6G SMF 406 may receive the identity of the SMF+PGW-C 404 that was serving the PDN connection and/or the PDU session. The 6G SMF 406 may then obtain the session management context from the SMF+PGW-C 404. The session management context may include the identity of the anchor UPF that serves the PDU session or PDN connection. The 6G SMF 406 may then use the session management context to establish the 6G PDU session, select the same anchor UPF 408 to serve the 6G PDU session, and ensure that the WTRU 401 maintains the same IP address. FIG. 5 shows an example procedure for how a WTRU 401 may establish a 6G PDU session establishment in the 6G network when moving from 4G or 5G.

Referring now to FIG. 5, a flow diagram illustrating an example method for moving a 6G PDU session establishment in the 6G network when moving from 4G or 5G. The method is performed using a WTRU 501, a 6G NF 502, an MME/AMF 503, a 6G SMF 504, a SMF+PGW-C 505 and a UPF 506.

At 511, the WTRU 501 may send a registration request to the 6G network.

At 512, the network function in the 6G network (e.g. a mobility management function, a registration function, or a context storage function) may be triggered by the registration request to retrieve the context of the WTRU 501 from the 4G network (e.g., the MME/AMF 503) or from the 5G network (e.g., AMF).

Alternatively or additionally, the network function may have no interface, or connection, to the MME/AMF 503. In this scenario, the context of the WTRU 501 may be retrieved from the UDM/UDR.

At 513, the network may send a registration response to the WTRU 501 to indicate that the registration was accepted (i.e. successful).

At 514, the WTRU 501 may send a 6G PDU session establishment request to a 6G SMF 504. The request includes the WTRU identifier and a PDU session ID.

At 515, the WTRU 501 may send a query to the network function that obtained the context of the WTRU 501 in 512. The query may include the WTRU identifier and the PDU session ID. The network function may respond to the query by sending the identity of the SMF+PGW-C 505 that served the PDU session or PDN connection.

At 516, the 6G SMF 504 may retrieve the session management context for the PDU session or PDN connection from the SMF+PGW-C 505. The session management context includes an IP address and the identity of a UPF 506.

At 517, the 6G SMF 504 may establish a connection to the UPF 506 because the 6G SMF 504 is not the serving node for the connection of the WTRU 501 to the data network.

At 518, the 6G SMF 504 may send a 6G PDU session establishment accept message to the WTRU 501. The message may indicate that the SM context of the WTRU 501 was successfully retrieved from the 4G or 5G network and/or includes the IP address that is associated with the 6G PDU session. The IP address may be the same IP address that was associated with the PDN connection or PDU session.

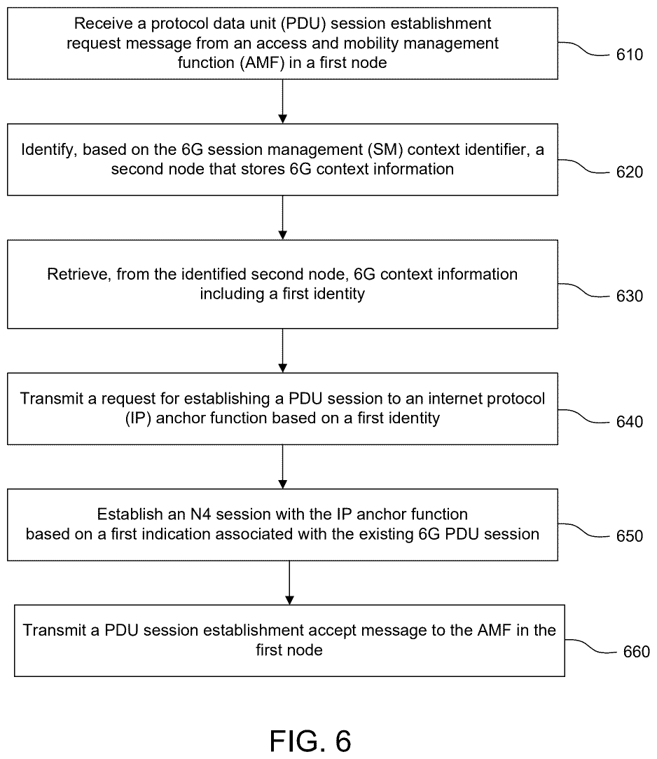

Referring now to FIG. 6, a flowchart illustrating an example process performed by a 5G SMF is shown according to one or more embodiments.

At 610, the 5G SMF receives a PDU session establishment request message from an AMF in a first node. The PDU session establishment request message comprises a 6G SM context identifier associated with an existing 6G PDU session. The PDU session establishment request message is indicative of an initial request for a new PDU session.

At 620, the 5G SMF identifies, based on the 6G SM context identifier, a second node that stores 6G context information. In an example, for identifying the second node that stores 6G context information, the 5G SMF performs a DNS lookup on the 6G SM context identifier and obtains an IP address of the second node. In an example, for identifying the second node that stores 6G context information comprises, the 5G SMF transmits the 6G SM context identifier to a NRF in a fourth node and receives from the NRF, an identity of the second node.

At 630, the 5G SMF retrieves the 6G context information from the identified second node. The 6G context information includes a first identity of an IP anchor function in a third node that serves the existing 6G PDU session. In an example, retrieving the 6G context information from the identified second node includes retrieving the 6G context information from one of: a server, a NF, UDR, or an UDSF.

In an example, the 5G SMF further transmits, based on the 6G context information, a PDU session establishment response message indicative of a capability of establishing the new PDU session based on an existing 6G PDU session.

At 640, the 5G SMF comprises transmitting a request for establishing a N4 session to the IP anchor function based on the first identity. The request includes a first indication associated with the existing 6G PDU session. In an example, the first indication includes an N4 session ID associated with the existing 6G PDU session.

At 650, the 5G SMF establishes an N4 session with the IP anchor function based on the first indication associated with the existing 6G PDU session. The N4 session is associated with the existing 6G PDU session.

At 660, the 5G SMF transmits a PDU session establishment accept message to the AMF. The PDU session establishment accept message includes a second indication associated with establishing the new PDU session based on an existing 6G PDU session.

In an example, the 6G context information further includes: a second identity of a policy control function (PCF) in a fourth node that serves the existing 6G PDU session, and a PCF session ID associated with the existing 6G PDU session. The 5G SMF transmits a request for establishing a session to the PCF based on the second identity. The request includes the PCF session ID associated with the existing 6G PDU session. The existing 6G PDU session and the new PDU session established based on the 6G existing PDU session are associated with same IP address. In an example, the second indication includes the same IP address.

Although aspects of the present disclosure are described in the context of sixth generation (6G) mobile networks, the described methods and apparatuses are not limited to 6G. Rather, they may be applied more generally to other generations of wireless communication technologies, including but not limited to improvements to 4G, 5G, and other future network generations. Moreover, the concepts disclosed herein may also be applicable across a variety of wireless and non-wireless communication systems that utilize session management, context transfer, and protocol data unit (PDU) session handling mechanisms.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a session management function (SMF) in a network node, the method comprising:
receiving, from an access and mobility management function (AMF) in a first node, a protocol data unit (PDU) session establishment request message comprising a sixth generation (6G) session management (SM) context identifier associated with an existing 6G PDU session, wherein the PDU session establishment request message is indicative of an initial request for a new PDU session;
identifying, based on the 6G SM context identifier, a second node that stores 6G context information;
retrieving the 6G context information from the identified second node, wherein the 6G context information includes a first identity of an internet protocol (IP) anchor function in a third node that serves the existing 6G PDU session;
transmitting a request for establishing an N4 session to the IP anchor function based on the first identity, wherein the request includes a first indication associated with the existing 6G PDU session;
establishing the N4 session with the IP anchor function based on the first indication associated with the existing 6G PDU session; and
transmitting a PDU session establishment accept message to the AMF, wherein the PDU session establishment accept message includes a second indication associated with establishing the new PDU session based on an existing 6G PDU session.

2. The method of claim 1, wherein identifying the second node that stores 6G context information comprises:
performing a domain name system (DNS) lookup on the 6G SM context identifier; and
obtaining an IP address of the second node.

3. The method of claim 1, wherein identifying the second node that stores 6G context information comprises:
transmitting the 6G SM context identifier to a network repository function (NRF) in a fourth node; and
receiving, from the NRF, an identity of the second node.

4. The method of claim 1, wherein retrieving the 6G context information from the identified second node includes retrieving the 6G context information from one of:
a server,
a network function (NF),
a user data repository (UDR), or
an unstructured data storage function (UDSF).

5. The method of claim 1, further comprising:
transmitting, based on the 6G context information, a PDU session establishment response message indicative of a capability of establishing the new PDU session based on an existing 6G PDU session.

6. The method of claim 1, wherein the first indication includes an N4 session identifier (ID) associated with the existing 6G PDU session.

7. The method of claim 1, wherein the 6G context information further includes:
a second identity of a policy control function (PCF) in a fourth node that serves the existing 6G PDU session, and
a PCF session ID associated with the existing 6G PDU session.

8. The method of claim 7, further comprising:
transmitting a request for establishing a session to the PCF based on the second identity, wherein the request includes the PCF session ID associated with the existing 6G PDU session.

9. The method of claim 1, wherein the existing 6G PDU session and the new PDU session established based on the 6G existing PDU session are associated with same IP address.

10. The method of claim 9, wherein the second indication includes the same IP address.

11. A network node, comprising:
a transceiver; and
a processor, wherein the transceiver and the processor are configured to:
receive, from an access and mobility management function (AMF) in a first node, a protocol data unit (PDU) session establishment request message comprising a sixth generation (6G) session management (SM) context identifier associated with an existing 6G PDU session, wherein the PDU session establishment request message is indicative of an initial request for a new PDU session,
identify, based on the 6G SM context identifier, a second node that stores 6G context information,
retrieve the 6G context information from the identified second node, wherein the 6G context information includes a first identity of an internet protocol (IP) anchor function in a third node that serves the existing 6G PDU session,
transmit a request for establishing an N4 session to the IP anchor function based on the first identity, wherein the request includes a first indication associated with the existing 6G PDU session,
establish the N4 session with the IP anchor function based on the first indication associated with the existing 6G PDU session, and
transmit a PDU session establishment accept message to the AMF, wherein the PDU session establishment accept message includes a second indication associated with establishing the new PDU session based on an existing 6G PDU session.

12. The network node of claim 11, wherein identifying the second node that stores 6G context information comprises:
performing a domain name system (DNS) lookup on the 6G SM context identifier, and
obtaining an IP address of the second node.

13. The network node of claim 11, wherein identifying the second node that stores 6G context information comprises:
transmitting the 6G SM context identifier to a network repository function (NRF) in a fourth node, and
receiving, from the NRF, an identity of the second node.

14. The network node of claim 11, wherein retrieving the 6G context information from the identified second node includes retrieving the 6G context information from one of:
a server,
a network function (NF),
a user data repository (UDR), or
an unstructured data storage function (UDSF).

15. The network node of claim 11, wherein the transceiver and the processor are further configured to:
transmit, based on the 6G context information, a PDU session establishment response message indicative of a capability of establishing the new PDU session based on an existing 6G PDU session.

16. The network node of claim 11, wherein the first indication includes an N4 session identifier (ID) associated with the existing 6G PDU session.

17. The network node of claim 11, wherein the 6G context information further includes:
a second identity of a policy control function (PCF) in a fourth node that serves the existing 6G PDU session, and
a PCF session ID associated with the existing 6G PDU session.

18. The network node of claim 17, wherein the transceiver and the processor are further configured to:
transmit a request for establishing a session to the PCF based on the second identity, wherein the request includes the PCF session ID associated with the existing 6G PDU session.

19. The network node of claim 11, wherein the existing 6G PDU session and the new PDU session established based on the 6G existing PDU session are associated with same IP address.

20. The network node of claim 19, wherein the second indication includes the same IP address.
